(19) United States
(12) Patent Application Publication
(10) Pub. No.: US 2023/0290126 A1
(43) Pub. Date: Sep. 14, 2023

(54) METHOD FOR TRAINING ROI DETECTION MODEL, METHOD FOR DETECTING ROI, DEVICE, AND MEDIUM

(71) Applicant: Beijing Baidu Netcom Science and Technology Co., Ltd., Beijing (CN)

(72) Inventors: Pengyuan LV, Beijing (CN); Sen FAN, Beijing (CN); Chengquan ZHANG, Beijing (CN); Kun YAO, Beijing (CN); Junyu HAN, Beijing (CN); Jingtuo LIU, Beijing (CN); Errui DING, Beijing (CN); Jingdong WANG, Beijing (CN)

(21) Appl. No.: 18/115,059

(22) Filed: Feb. 28, 2023

(30) Foreign Application Priority Data
Mar. 11, 2022 (CN) 202210239359.9

(51) Int. Cl. G06V 10/774; G06V 10/77; G06V 10/42; G06V 10/44; G06V 10/25

(52) U.S. Cl. CPC G06V 10/7747; G06V 10/25; G06V 10/42; G06V 10/44; G06V 10/7715; G06V 30/148

(57) ABSTRACT

Provided are a method for training a region of interest (ROI) detection model, a method for detecting an ROI, a device, and a medium. The specific implementation includes: performing feature extraction on a sample image to obtain a sample feature data; performing non-linear mapping on the sample feature data to obtain a first feature data and a second feature data; determining an inter-region difference data according to the second feature data and a third feature data of the first feature data in a region associated with a label ROI; and adjusting at least one of a to-be-trained feature extraction parameter and a to-be-trained feature enhancement parameter of the ROI detection model according to the inter-region difference data and the region associated with the label ROI.

### CROSS-REFERENCE TO RELATED APPLICATIONS

This application claims priority to Chinese Patent Application No. 202210239359.9 filed Mar. 11, 2022, the disclosure of which is incorporated herein by reference in its entirety.

### TECHNICAL FIELD

The present disclosure relates to the field of artificial intelligence, in particular, to computer vision and deep learning, and specifically, to a method and apparatus for training a region of interest (ROI) detection model, a method and apparatus for detecting an ROI, a device, and a computer-readable medium.

### BACKGROUND

In the field of image processing, a region of interest (ROI) is an image region selected from an image and is a focus of attention in image analysis. Such a region is defined and taken as a prerequisite for further processing of the image, the image processing time can be reduced and the image processing precision can be increased.

### SUMMARY

The present disclosure provides a method and apparatus for training an ROI detection model, a method and apparatus for detecting an ROI, a device, and a medium.

According to an aspect of the present disclosure, a method for training an ROI detection model is provided. The method includes the steps described below.

Feature extraction is performed on a sample image to obtain a sample feature data.

Non-linear mapping is performed on the sample feature data to obtain a first feature data and a second feature data, where the first feature data indicates a feature mapping result in a query space, and the second feature data indicates a feature mapping result in a value space.

An inter-region difference data is determined according to the second feature data and a third feature data of the first feature data in a region associated with a label ROI.

A to-be-trained parameter of the ROI detection model is adjusted according to the inter-region difference data and the region associated with the label ROI.

According to another aspect of the present disclosure, a method for detecting an ROI is further provided. The method includes the steps described below.

Feature extraction is performed on a to-be-detected image according to a trained feature extraction parameter to obtain a prediction feature data, where the feature extraction parameter is trained using any method for training an ROI detection model provided by embodiments of the present disclosure.

Decoding processing is performed on the prediction feature data according to a trained decoding parameter to obtain an ROI prediction result.

According to another aspect of the present disclosure, an electronic device is further provided. The electronic device includes at least one processor and a memory communicatively connected to the at least one processor.

The memory is configured to store instructions executable by the at least one processor, and the instructions are executed by the at least one processor to enable the at least one processor to perform any method for training an ROI detection model provided by the embodiments of the present disclosure or perform any method for detecting an ROI provided by the embodiments of the present disclosure.

According to another aspect of the present disclosure, a non-transitory computer-readable storage medium is provided, which stores computer instructions for causing a computer to perform the training method for a target detection model according to any embodiment of the present disclosure or the target detection method according to any embodiment of the present disclosure.

According to the technology of the present disclosure, the detection precision of the ROI detection model is improved.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure. In the drawings:

FIG. 1A is a structural diagram of an ROI detection model according to an embodiment of the present disclosure;

FIG. 1B is a structural diagram of an ROI detection model according to the related art;

FIG. 1C is a flowchart of a method for training an ROI detection model according to an embodiment of the present disclosure;

FIG. 2A is a flowchart of a method for training an ROI detection model according to an embodiment of the present disclosure;

FIG. 2B is a structural diagram of a feature enhancement module according to an embodiment of the present disclosure;

FIG. 3 is a flowchart of a method for training an ROI detection model according to an embodiment of the present disclosure;

FIG. 4 is a structural diagram of a text region detection model according to an embodiment of the present disclosure;

FIG. 5 is a flowchart of a method for detection an ROI according to an embodiment of the present disclosure;

FIG. 6 is a structural diagram of an apparatus for training an ROI detection model according to an embodiment of the present disclosure;

FIG. 7 is a structural diagram of an apparatus for detecting an ROI according to an embodiment of the present disclosure; and

FIG. 8 is a block diagram of an electronic device for performing a method for training an ROI detection model and/or a method for detecting an ROI according to an embodiment of the present disclosure.

### DETAILED DESCRIPTION

Example embodiments of the present disclosure, including details of embodiments of the present disclosure, are described herein in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

The method for training an ROI detection model provided by the present disclosure is suitable for the application scenario where a pre-constructed deep learning model is trained to enable the model to have an ROI detection capability. The ROI may be a region where a preset target is located in an image, such as a text region, a face region, a vehicle region and the like. The preset target may be set according to actual requirements. The method for training an ROI detection model provided by the present disclosure can be executed by an apparatus for training an ROI detection model. The apparatus can be implemented by software and/or hardware and is specifically configured in an electronic device.

For ease of understanding, the structure of the ROI detection model is described in detail first.

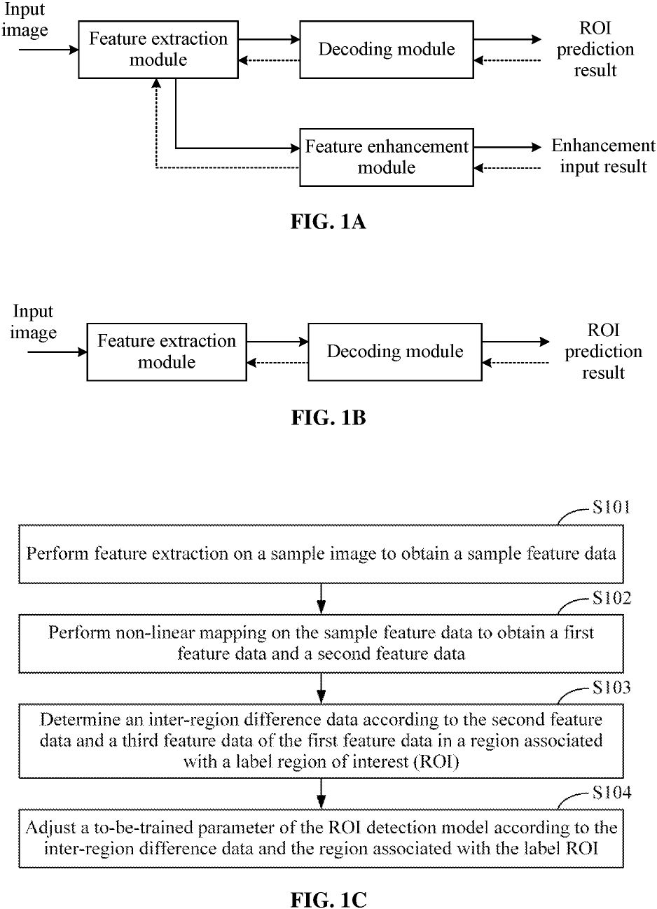

With reference to FIG. 1A, the ROI detection model includes a feature extraction module and a feature enhancement module. The feature extraction module is configured to perform feature extraction on an input image, and the feature enhancement module is configured to perform feature enhancement on an output result of the feature extraction module, so as to optimize and adjust the to-be-trained parameters of the feature extraction module and the feature enhancement module in the ROI detection model according to the enhancement output result of the feature enhancement module, thereby improving the feature extraction capability of the feature extraction module.

Further, the ROI detection model may further include a decoding module. The decoding module is configured to perform ROI prediction according to the output result of the feature extraction module, and optimize and adjust the to-be-trained parameters of the feature extraction module and the decoding module according to an ROI prediction result and a pre-labelled label ROI region.

With reference to FIG. 1B, the ROI detection model in the related art only includes a feature extraction module and a decoding module. Feature extraction is performed on an input image through the feature extraction module, ROI prediction is performed according to an output result of the feature extraction module through the decoding module, and the to-be-trained parameters of the feature extraction module and the decoding module are optimized and adjusted according to an ROI prediction result and a pre-labelled label ROI region.

Compared with the ROI detection model of the related art shown in FIG. 1B, for the ROI detection model of the present disclosure shown in FIG. 1A, since the feature enhancement module is introduced in the present disclosure to assist in optimizing the to-be-trained parameters of the feature extraction module, the feature extraction capability of the feature extraction module is improved, thereby improving the detection capability of the ROI detection model.

The method for training an ROI detection model provided by the present disclosure is described in detail below based on the ROI detection model shown in FIG. 1A.

With reference to FIG. 1C, the method for training an ROI detection model includes S101, S102, S103 and S104, where the ROI detection model includes a feature extraction module and a feature enhancement module.

In S101, feature extraction is performed on a sample image to obtain a sample feature data.

The sample image is a training sample used when the ROI detection model is trained. In order to ensure the model precision of the trained model, the number of sample images is usually multiple and the sample images are diverse.

The sample feature data may be understood as an abstract representation of the sample image.

It is to be understood that the feature extraction module performs feature extraction on the sample image to obtain the ROI-relevant information in the sample image and eliminate the ROI-irrelevant information in the sample image.

In S102, non-linear mapping is performed on the sample feature data to obtain a first feature data and a second feature data.

The first feature data and the second feature data may be regarded as the results of non-linear mapping of the sample feature data to a feature space. The first feature data indicates a feature mapping result of the sample feature data in a query space, and the second feature data indicates a feature mapping result of the sample feature data in a value space. It is to be noted that the first feature data and the second feature data are determined through non-linear mapping, thereby contributing to the improvement of the fitting capability of the ROI detection model.

Since the first feature data and the second feature data are the same data, that is, the first feature data and the second feature data are the space mapping results of the sample feature data, both the first feature data and the second feature data carry the key information in the sample feature data.

It is to be noted that the query space corresponding to the first feature data and the value space corresponding to the second feature data may be the same or different and are not limited to the present disclosure. In order to improve the flexibility and universality of the ROI detection model, two different non-linear mapping branches are usually set in the feature enhancement module to determine the first feature data and the second feature data, respectively, and through the training of the ROI detection model based on a large number of sample images, non-linear mapping in the same feature space or different feature spaces is performed.

In S103, an inter-region difference data is determined according to the second feature data and a third feature data of the first feature data in a region associated with a label ROI.

The label ROI is a pre-labeled ROI in the sample image, and the specific labeling manner is not limited to the present disclosure. The region associated with the label ROI may be a region that has a certain association relationship with the region where the label ROI is located in each region of the sample image, and for example, the region associated with the label ROI may be the region of the label ROI itself or a local region of the label ROI. In a specific embodiment, the local region of the label ROI may be a central region of the label ROI.

It is to be noted that the third feature data of the first feature data in the region associated with the label ROI may be understood as a result of mapping the key information of the region associated with the label ROI in the sample feature data to the query space. Since the second feature data includes the result of mapping information of the sample feature data in the region associated with the label ROI to the query space and the result of mapping the information of the sample feature data of other regions other than the region associated with the label ROI to the query space, the inter-region difference data determined according to the third feature data and the feature data of the second feature data in the region associated with the label ROI can represent the contrast difference between the information carried in the region associated with the label ROI and the information carried in other regions other than the region associated with the label ROI so that feature enhancement is performed on the region associated with the label ROI to a certain extent.

In S104, a to-be-trained parameter of the ROI detection model is adjusted according to the inter-region difference data and the region associated with the label ROI.

Since the inter-region difference data is the feature enhancement result of the region associated with the label ROI, the higher the matching between the feature enhancement result and the region associated with the label ROI, the smaller the difference, indicating that the feature extraction capability of the feature extraction module and the feature enhancement capability of the feature enhancement module in the ROI detection model are better; the lower the matching between the feature enhancement result and the region associated with the label ROI, the larger the difference, indicating that the feature extraction capability of the feature extraction module or the feature enhancement capability of the feature enhancement module in the ROI detection model is poorer. In view of this, the to-be-trained parameter of the ROI detection model, such as at least one of the feature extraction parameter of the feature extraction module and the feature enhancement parameter of the feature enhancement module, may be optimized according to the difference between the inter-region difference data and the region associated with the label ROI to continuously improve the feature extraction capability of the feature extraction module and the feature enhancement capability of the feature enhancement module, thereby achieving the purpose of training the ROI detection model.

In this embodiment of the present disclosure, non-linear mapping is performed on the sample feature data obtained by extracting the sample image to obtain the first feature data in the query space and the second feature data in the value space, the inter-region difference data is determined according to the second feature data and the third feature data of the first feature data in the region associated with the label ROI to represent the contrast difference in the non-linear mapping results in the region associated with the label ROI and a region not associated with the label ROI, and the to-be-trained parameter of the ROI detection model is adjusted according to the inter-region difference data, so as to achieve the purpose of training the ROI detection model. Therefore, the feature extraction capability of the ROI detection model is improved, the extraction of irrelevant information is avoided, and the loss of key information is avoided, thereby ensuring the accuracy and comprehensiveness of the extracted feature and further improving the ROI detection capability of the trained ROI detection model.

On the basis of the solutions described above, the present disclosure further provides an optional embodiment. In this optional embodiment, the determination mechanism of the inter-region difference data in S103 is optimized and improved. It is to be noted that for parts that are not described in detail in this optional embodiment, reference may be made to the description of the embodiments describe above.

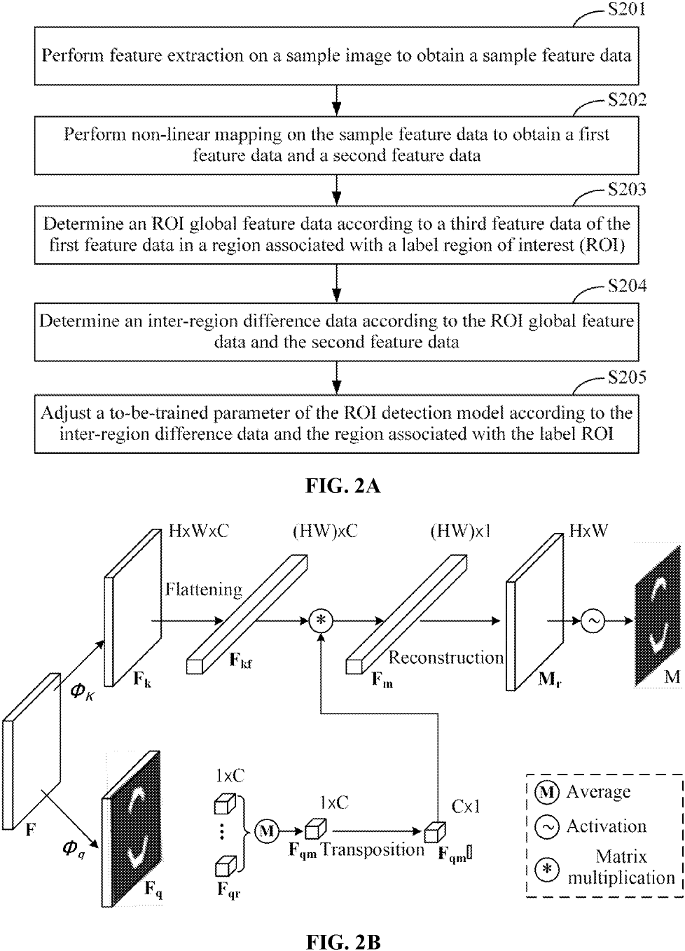

With reference to FIG. 2A, the method for training an ROI detection model includes S201, S202, S203, S204 and S205.

In S201, feature extraction is performed on a sample image to obtain a sample feature data.

In S202, non-linear mapping is performed on the sample feature data to obtain a first feature data and a second feature data.

In S203, an ROI global feature data is determined according to a third feature data of the first feature data in a region associated with a label ROI.

The ROI global feature data is used for representing the key information of the region associated with the label ROI from a global perspective.

In an optional embodiment, the average value of the third feature data may be determined according to a channel, and a determination result may be taken as the ROI global feature data.

However, the processing of all the third feature data of the region associated with the label ROI increases the computation amount. In order to improve the computation efficiency and reduce the computation cost, in another optional embodiment, sampling may further be performed on the third feature data to obtain an ROI reference feature data, and the ROI global feature data is determined according to the ROI reference feature data. The ROI reference feature data may be at least one group, and the specific number of the ROI reference feature data is not limited to the present disclosure.

It is to be noted that the sampling manner and the sampling rate are not limited to the present disclosure and may be set or adjusted by technicians according to requirements or determined through a large number of trials. For example, a set number of groups of ROI reference feature data may be obtained by random sampling.

Optionally, one group of ROI reference feature data may be selected and directly taken as the ROI global feature data. Alternatively, the average value of at least one group of ROI reference feature data may be determined according to a channel dimension, and a determined result may be used as the ROI global feature data.

In a specific embodiment, the third feature data is treated indiscriminately by random sampling, the average value of each group of ROI reference feature data is determined according to the channel dimension, and the determination result is taken as the ROI global feature data, thereby avoiding the omission of the key information and contributing to the improvement of the accuracy and comprehensiveness of the information carried by the ROI global feature data.

It is to be understood that sampling processing is performed on the third feature data, and the ROI reference feature data obtained by sampling is used to replace the full third feature data in the region associated with the label ROI, so as to determine the ROI global feature data, thereby significantly reducing the computation amount and improving the computation efficiency.

In S204, an inter-region difference data is determined according to the ROI global feature data and the second feature data.

Since the ROI global feature data may represent the key information in the region associated with the label ROI from the global perspective, the inter-region difference data representing the contrast difference between the region associated with the label region and a region associated with the label ROI may be determined according to the ROI global feature data in the query space and the second feature data in the value space.

In an optional embodiment, feature enhancement may be performed on the second feature data according to the ROI global feature data to obtain an ROI enhancement feature data, and activation processing is performed on the ROI enhancement feature data to obtain the inter-region difference data.

Feature enhancement is performed on the second feature data through the ROI global feature data, so as to enhance the feature of the region associated with the label ROI in the second feature data and weaken the feature of the region associated with the label ROI in the second feature data (another feature other than the third feature data in the first feature data); activation processing is performed on the ROI feature enhancement data, and the ROI feature enhancement data is mapped to a preset feature space to obtain the inter-region difference data. The preset feature space may be determined or adjusted by technicians according to requirements or empirical values and is not limited to the present disclosure, for example, the preset feature space may be a space of 0-1. The activation function for activation processing is not limited to the present disclosure and may be set or adjusted according to requirements or determined through a large number of trials.

If the preset feature space is a space of 0-1, the inter-region difference data may be used for representing the similarity between the second feature data and the ROI global feature data. If the value of the similarity corresponding to a pixel point approaches 0, the similarity between the second feature value of the pixel point and the ROI global feature value is lower, that is, the probability that the corresponding pixel point is the region associated with the label ROI is higher; if the value of the similarity corresponding to the pixel point approaches 1, the similarity between the second feature value of the pixel point and the ROI global feature value is higher, that is, the probability that the corresponding pixel point is the region associated with the label ROI is higher.

It is to be understood that in the solutions described above, feature enhancement and activation processing are introduced to determine the inter-region difference data, thereby improving the determination mechanism of the inter-region difference data and providing the data support for the subsequent adjustment of the to-be-trained parameter of the ROI detection model. Because of the convenient operation of feature enhancement and activation processing, the determination efficiency of the inter-region difference data is improved and the computation amount is reduced.

The determination process of the inter-region difference data is further described in detail in conjunction with the structural diagram of the feature enhancement module shown in FIG. 2B.

The sample feature data F output by the feature extraction module is non-linearly mapped to the query space (φq is a non-linear mapping parameter obtained through model training) to obtain a first feature data Fq of an H×W×C dimension, and the sample feature data F is non-linearly mapped to the value space (φk is a non-linear mapping parameter obtained by model training) to obtain a second feature data Fk of the H×W×C dimension. Random sampling is performed on the third feature data of the first feature data Fq in the region associated with the label ROI to obtain N (N≥1) groups of ROI reference feature data Fqr of a 1×C dimension; average value processing is performed on N groups of ROI reference feature data Fqr according to a channel dimension, and the obtained average feature is taken as the ROI global feature data Fqm; transposition is performed on the global feature data of ROI to obtain a transposition result Fqm′ of a C×1 dimension. Flattening processing is performed on the second feature data Fk of the HxWxC dimension to obtain a flattening result Fkf of an (HW)×C dimension; matrix multiplication is performed on the flattening result Fkf and the transposition result Fqm′ to obtain an initial enhancement feature Fm of an (HW)×1 dimension; feature reconstruction is performed on the initial enhancement feature Fm to obtain an ROI enhancement feature data Mr of an H×W dimension; activation processing is performed on the ROI enhancement feature data Mr to obtain a matrix difference data M of the H×W dimension.

It is to be noted that the type and number of the region associated with the label ROI are not limited to the present disclosure. For different regions associated with the label ROI, the corresponding inter-region difference data may be determined using the manner described above respectively.

In S205, a to-be-trained parameter of the ROI detection model is adjusted according to the inter-region difference data and the region associated with the label ROI.

In this embodiment of the present disclosure, the operation of determining the inter-region difference data is refined into steps where the ROI global feature data is determined according to the feature data of the first feature data in the region associated with the label ROI and the inter-region difference data between the region associated with the label ROI and the region not associated with the label ROI in the query space and value space is determined according to the second feature data and the ROI global feature data representing the global feature of the region associated with the label ROI, thereby improving the determination mechanism of the inter-region difference data and providing the data support for the subsequent adjustment of the to-be-trained parameter of the ROI detection model.

On the basis of the solutions described above, the present disclosure further provides an optional embodiment. In this optional embodiment, the adjustment mechanism of the to-be-trained parameter in S104 is optimized and improved.

With reference to FIG. 3, the method for training an ROI detection model includes S301, S302, S303, S304 and S305.

In S301, feature extraction is performed on a sample image to obtain a sample feature data.

In S302, non-linear mapping is performed on the sample feature data to obtain a first feature data and a second feature data.

In S303, an inter-region difference data is determined according to the second feature data and a third feature data of the first feature data in a region associated with a label ROI.

In S304, a target feature extraction loss is determined according to the inter-region difference data and the region associated with the label ROI.

The target feature extraction loss represents the difference degree between the inter-region difference data output by the feature enhancement module and the actually desired region associated with the label ROI and reflects the feature extraction capability of the feature extraction module. If the difference degree is large, it indicates that the feature extraction capability of the feature extraction module is weak, and there may be the loss of key information or the extraction of irrelevant information. If the difference degree is small, it indicates that the feature extraction capability of the feature extraction module is strong.

For example, the target feature extraction loss may be determined according to the difference between the inter-region difference data and the region associated with the label ROI.

Specifically, the target feature extraction loss may be determined according to the inter-region difference data and the region associated with the label ROI based on a preset loss function. The preset loss function may be set or adjusted by technicians according to requirements or empirical values or determined through a large number of trials and is not limited to the present disclosure.

It is to be noted that if the region associated with the label ROI is a single region, one target feature extraction loss may be determined. If the region associated with the label ROI includes at least two regions, the corresponding feature extraction loss may be determined for each region associated with the label ROI respectively, for reflecting the feature extraction capability of the feature extraction network to the different regions associated with the label ROI. Accordingly, the target feature extraction loss is determined according to each feature extraction loss.

Optionally, the region associated with the label ROI may include a label ROI that is used for measuring the feature extraction capability of the feature extraction module from a global perspective of the label ROI. Alternatively, optionally, the region associated with the label ROI may include a local region of the label ROI, which is used for measuring the feature extraction capability of the feature extraction module from a local region perspective of the label ROI. The number of local regions of the label ROI may be at least one. For example, the local region of the label ROI may be the central region of the label ROI.

It is to be understood that the region associated with the label ROI is refined into the label ROI and/or the local region of the label ROI, thereby improving the richness and diversity of the subsequently determined inter-region difference data and contributing to the improvement of the diversity of the method for training an ROI detection model.

In an optional embodiment, if the region associated with the label ROI includes the label ROI and the local region of the label ROI, the first feature extraction loss may be determined according to the inter-region difference data corresponding to the label ROI and the label ROI, the second feature extraction loss is determined according to the inter-region difference data corresponding to the local region of the label ROI and the local region of the label ROI, and the target feature extraction loss is determined according to the first feature extraction loss and the second feature extraction loss.

For example, the second feature extraction loss may be determined according to the inter-region difference data corresponding to the label ROI and the label ROI based on a first preset loss function, the second feature extraction loss is determined according to the inter-region difference data corresponding to the local region of the label ROI and the local region of the label ROI based on a second preset loss function, and the target feature extraction loss is determined according to a weighted average value of the first feature extraction loss and the second feature extraction loss. The first preset loss function and the second preset loss function may be set or adjusted by technicians according to requirements or empirical values; the first preset loss function and the second preset loss function may be the same or different and are not limited to the present disclosure. When the target feature extraction loss is determined, the weights corresponding to different feature extraction losses may be set or adjusted by technicians according to requirements or empirical values, and the specific values of the weights are not limited to the present disclosure.

It is to be noted that if the number of local regions of the label ROI is at least one, the corresponding number of determined second feature extraction losses is also at least one.

It is to be understood that the region associated with the label ROI is refined into two types of data, that is, the label ROI and the local region of the label ROI, so that the inter-region difference data corresponding to different types is determined based on the above data, thereby improving the richness and diversity of the inter-region difference data. Meanwhile, the corresponding feature extraction losses are determined according to the inter-region difference data of different types and the corresponding regions associated with the label ROI and taken as the basis of determining the target feature extraction loss. The computation process is convenient and fast and the computation amount is small, thereby improving the computation efficiency of the target feature extraction loss.

In S305, a to-be-trained feature extraction parameter and a to-be-trained feature enhancement parameter are adjusted according to the target feature extraction loss.

The to-be-trained feature extraction parameter may be understood as the to-be-trained parameter in the feature extraction module for feature extraction, and the to-be-trained feature enhancement parameter may be understood as the to-be-trained parameter in the feature enhancement module for feature enhancement (such as non-linear mapping and the determination of the inter-region difference data).

The to-be-trained parameters of the feature extraction module and the feature enhancement module are adjusted according to the target feature extraction loss so that the feature extraction efficiency of the feature extraction module in the ROI detection model is gradually improved and the inter-region difference data output by the feature enhancement module is continuously approached to the corresponding region associated with the label ROI, thereby improving the feature extraction capability of the feature extraction module in the ROI detection model.

Specifically, the to-be-trained parameters of the feature extraction module and the feature enhancement module may be adjusted according to the target feature extraction loss based on a preset gradient function. The preset gradient function may be set or adjusted by technicians according to requirements or empirical values or determined through a large number of trials and is not limited to the present disclosure.

In an optional embodiment, the target prediction loss may also be determined according to a prediction ROI output by the decoding module in the ROI detection model and the label ROI, and the to-be-trained parameter of the ROI detection model is adjusted according to the target prediction loss. For example, the feature extraction parameter of the feature extraction module and/or the decoding parameter of the decoding module in the ROI detection model may be adjusted according to the target prediction loss.

It is to be understood that the to-be-trained parameter of the feature extraction module is adjusted jointly through the target prediction loss and the target feature extraction loss so that the feature extraction capability of the feature extraction module is improved and the feature extracted by the feature extraction module matches the ROI detection requirements better, thereby contributing to the improvement of the overall detection capability of the ROI detection model.

In this embodiment of the present disclosure, the operation of adjusting the to-be-trained parameters of the ROI detection model is refined into: the target feature extraction loss is determined according to the inter-region difference data and the region associated with the label ROI, representing the feature extraction capability of the feature extraction module in the ROI detection model, and the to-be-trained parameters of the feature extraction module and the feature enhancement module are adjusted through the target feature extraction loss so that the sensitivity of the feature extraction module to the contrast difference feature between the region associated with the label ROI and the region not associated with the label ROI is improved, thereby improving the feature extraction capability of the feature extraction module and providing a guarantee for the improvement of the detection accuracy of the ROI detection model.

The training process of the text region detection model (that is, the ROI detection model described above) is described in detail below using an example where the label ROI is taken as a label text region and accordingly, the region associated with the label ROI includes the label text region and a label text central region.

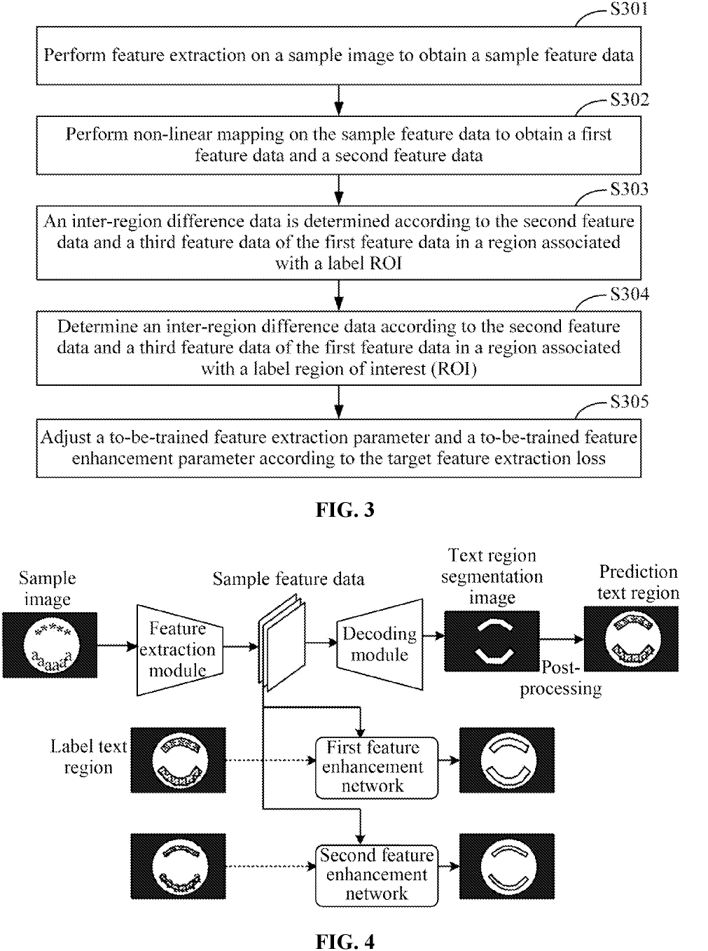

With reference to FIG. 4, the text region detection model includes a feature extraction module, a feature enhancement module and a decoding module. The feature enhancement module includes a first feature enhancement network and a second feature enhancement network.

Feature extraction is performed on an input sample image through the feature extraction model to obtain a sample feature data.

Non-linear mapping is performed on the sample feature data through the first feature enhancement network to obtain a first feature data in a first query space and a second feature data in a first value space respectively, a feature data of the first feature data in the first query space in the label text region is taken as a third feature data in the first query space, and a first inter-region difference data is determined according to the second feature data in the first value space and the third feature data in the first query space through the first feature enhancement network.

Non-linear mapping is performed on the sample feature data through the second feature enhancement network to obtain a first feature data in a second query space and a second feature data in a second value space respectively, a feature data of the first feature data in the second query space in the label text central region is taken as a third feature data in the second query space, and a second inter-region difference data is determined according to the second feature data in the second value space and the third feature data in the second query space through the second feature enhancement network.

Decoding processing is performed on the sample feature data through the decoding module to obtain a text region segmentation image, and post-processing such as binarization and connected domain determination is performed on the text region segmentation image to obtain a prediction text region.

A first feature extraction loss is determined according to the first inter-region difference data and the label text region, a second feature extraction loss is determined according to the second inter-region difference data and the label text central region, a target feature extraction loss is obtained by weighting according to the first feature extraction loss and the second feature extraction loss, and a feature extraction parameter of the feature extraction module and a feature enhancement parameter of the feature enhancement module are optimized according to the target feature extraction loss.

A prediction loss is determined according to the prediction text region and the label text region, and the feature extraction parameter of the feature extraction module and a decoding parameter of the decoding module are optimized according to the prediction loss.

It is to be noted that the parts where non-linear mapping is performed of the first feature enhancement network and the second feature enhancement network may be combined, that is, the first feature enhancement network and the second feature enhancement network share the first feature data in the same query space and the second feature data in the same value space, thereby reducing the data computation amount.

The decoding module may be implemented using any decoding network in the related art and is not limited to the present disclosure. For example, the decoding module may be a segmentation-based decoding module, that is, the sample image is classified into three categories of “background-text central region-text boundary” according to the sample feature data to determine the classification result of each pixel point in the sample image, so as to obtain the text region segmentation image, and post-processing such as binarization and connected domain determination is performed on the text region segmentation image to obtain the prediction text region.

Different feature enhancement networks perform the operation of determining the inter-region difference data. For the determination operation, reference may be made to the relevant description of the feature enhancement module in the embodiments described above, and details will not be repeated herein.

In this solution, the first inter-region difference data corresponding to the label text region and the second inter-region difference data corresponding to the label text central region are introduced to determine the target feature extraction loss, and the to-be-trained parameter of the feature extraction module is continuously optimized through the target feature extraction loss, thereby improving the feature extraction capability of the feature extraction module and improving the accuracy of the detection result of the trained text region detection model.

On the basis of the solutions described above, the present disclosure further provides an optional embodiment of a method for detecting an ROI. This optional embodiment is suitable for the application scenario where the ROI detection model trained in the embodiments described above performs ROI detection. The method for detecting an ROI provided by the present disclosure can be executed by an apparatus for detecting an ROI. The apparatus can be implemented by software and/or hardware and is specifically configured in an electronic device. It is to be noted that the electronic device performing the method for detecting an ROI and the electronic device performing the method for training an ROI detection model described above may be the same or different and is not limited to the present disclosure.

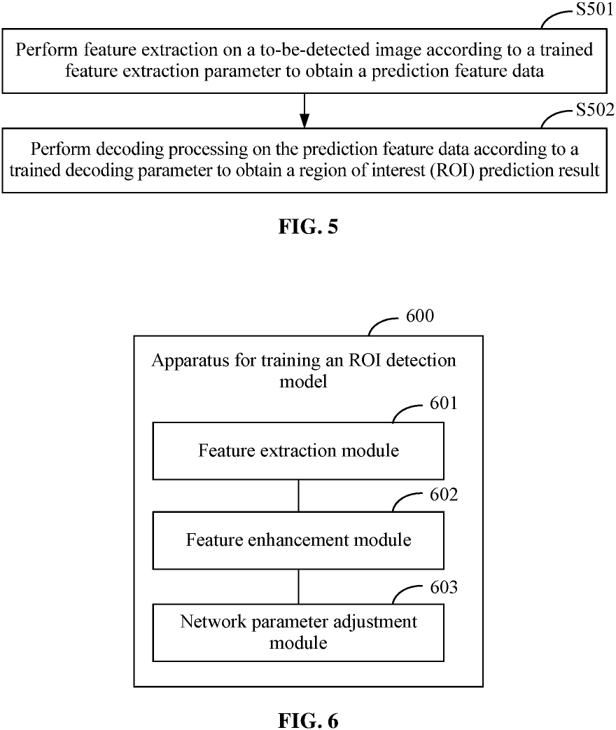

With reference to FIG. 5, the method for detecting an ROI includes S501 and S502.

In S501, feature extraction is performed on a to-be-detected image according to a trained feature extraction parameter to obtain a prediction feature data.

The feature extraction parameter is trained using the method for training an ROI detection model provided by the embodiments of the present disclosure.

It is to be noted that during ROI prediction, a trained ROI detection model may be acquired, and the feature extraction operation may be performed using the trained feature extraction parameter in the ROI detection model as data support for the ROI detection operation.

In the operation of acquiring the ROI detection model, the trained complete ROI detection model may be directly acquired and stored, or the feature enhancement module in the trained ROI detection model may be eliminated and the eliminated ROI detection model may be stored. Accordingly, the stored ROI detection model is used for performing feature extraction and the subsequent decoding operation. It is to be understood that the storage and use of the ROI detection model obtained after elimination processing may reduce the storage space and the data computation amount of the ROI detection model and is not limited to the present disclosure.

In S502, decoding processing is performed on the prediction feature data according to a trained decoding parameter to obtain an ROI prediction result.

For example, decoding processing may be performed on the prediction feature data through the decoding module in the ROI detection model to obtain an ROI segmentation image, binarization is performed on the ROI segmentation image, and a connected domain is calculated according to the binarization result to obtain the ROI prediction result.

In this embodiment of the present disclosure, feature extraction is performed on the to-be-detected image using the trained feature extraction parameter to obtain the prediction feature data, and decoding processing is performed on the prediction feature data according to the trained decoding parameter to obtain the ROI detection result. In the training process of the feature extraction parameter, the first feature data in the query space and the second feature data in the value space are introduced to determine the inter-region difference data between the region associated with the label ROI and the region not associated with the label ROI, and the to-be-trained parameter including the feature extraction parameter in the ROI detection model is adjusted according to the inter-region difference data so that the feature extraction capability of the trained feature extraction parameter is better, thereby significantly improving the accuracy of the obtained ROI prediction result during ROI prediction.

As the implementation of the method for training an ROI detection model described above, the present disclosure further provides an optional embodiment of an apparatus for performing the method for training an ROI detection model. Further, with reference to FIG. 6, the apparatus 600 for training an ROI detection model includes a feature extraction module 601, a feature enhancement module 602 and a network parameter adjustment module 603. The apparatus 600 for training an ROI detection model is used for performing model training on an ROI detection model, where the ROI detection model includes the feature extraction module 601 and the feature enhancement module 602.

The feature extraction model 601 is configured to perform feature extraction on a sample image to obtain a sample feature data.

The feature enhancement module 602 is configured to perform non-linear mapping on the sample feature data to obtain a first feature data and a second feature data.

The feature enhancement module 602 is further configured to determine an inter-region difference data according to the second feature data and a feature data of the first feature data in a region associated with a label ROI.

The network parameter adjustment module 603 is configured to adjust a to-be-trained parameter of the ROI detection model according to the inter-region difference data and the region associated with the label ROI.

In this embodiment of the present disclosure, in the ROI detection model, non-linear mapping is performed on the sample feature data obtained by extracting the sample image to obtain the first feature data in the query space and the second feature data in the value space, the inter-region difference data is determined according to the second feature data and the third feature data of the first feature data in the region associated with the label ROI to represent the contrast difference in the non-linear mapping results in the region associated with the label ROI and the region not associated with the label ROI, and the to-be-trained parameter of the ROI detection model is adjusted according to the inter-region difference data, so as to achieve the purpose of training the ROI detection model. Therefore, the feature extraction capability of the feature extraction module in the ROI detection model is improved, the extraction of irrelevant information is avoided, and the loss of key information is avoided, thereby ensuring the accuracy and comprehensiveness of the extracted feature and further improving the ROI detection capability of the trained ROI detection model.

In an optional embodiment, the feature enhancement module 602 includes an ROI global feature data determination unit and an inter-region difference data determination unit.

The ROI global feature data determination unit is configured to determine an ROI global feature data according to the third feature data.

The inter-region difference data determination unit is configured to determine the inter-region difference data according to the ROI global feature data and the second feature data.

In one optional embodiment, the inter-region difference data determination unit includes a feature enhancement sub-unit and an activation processing sub-unit.

The feature enhancement sub-unit is configured to perform feature enhancement on the second feature data according to the ROI global feature data to obtain an ROI enhancement feature data.

The activation processing sub-unit is configured to perform activation processing on the ROI enhancement feature data to obtain the inter-region difference data.

In one optional embodiment, the ROI global feature data determination unit includes a data sampling sub-unit and an ROI global feature data determination sub-unit.

The data sampling sub-unit is configured to perform sampling on the third feature data to obtain an ROI reference feature data.

The ROI global feature data determination sub-unit is configured to determine the ROI global feature data according to the ROI reference feature data.

In an optional embodiment, the network parameter adjustment module 603 includes a target feature extraction loss determination unit and a network parameter adjustment unit.

The target feature extraction loss determination unit is configured to determine a target feature extraction loss according to the inter-region difference data and the region associated with the label ROI.

The network parameter adjustment unit is configured to adjust a to-be-trained feature extraction parameter and a to-be-trained feature enhancement parameter according to the target feature extraction loss.

In an optional embodiment, the region associated with the label ROI includes at least one of: the label ROI or a local region of the label ROI.

In an optional embodiment, if the region associated with the label ROI includes the label ROI and the local region of the label ROI, the target feature extraction loss determination unit includes a first loss determination sub-unit, a second loss determination sub-unit and a target feature extraction loss determination sub-unit.

The first loss determination sub-unit is configured to determine a first feature extraction loss according to the label ROI and an inter-region difference data corresponding to the label ROI.

The second loss determination sub-unit is configured to determine a second feature extraction loss according to an inter-region difference data corresponding to the local region of the label ROI and the local region of the label ROI.

The target feature extraction loss determination sub-unit is configured to determine the target feature extraction loss according to the first feature extraction loss and the second feature extraction loss.

In an optional embodiment, the local region of the label ROI includes a central region of the label ROI.

The apparatus for training an ROI detection model may perform the method for training an ROI detection model provided by any embodiment of the present disclosure and has functional modules and beneficial effects corresponding to the performed method for training an ROI detection model.

As the implementation of the method for detecting an ROI described above, the present disclosure further provides an optional embodiment of an apparatus for performing the method for predicting an ROI. Further, with reference to FIG. 7, the apparatus 700 for detecting an ROI includes a feature extraction module 701 and a decoding module 702.

The feature extraction module 701 is configured to perform feature extraction on a to-be-detected image according to a trained feature extraction parameter to obtain a prediction feature data, where the feature extraction parameter is trained using any apparatus for training an ROI detection model provided by the embodiments of the present disclosure.

The decoding module 702 is configured to perform decoding processing on the prediction feature data according to a trained decoding parameter to obtain an ROI prediction result.

In this embodiment of the present disclosure, feature extraction is performed on the to-be-detected image using the trained feature extraction parameter to obtain the prediction feature data, and decoding processing is performed on the prediction feature data according to the trained decoding parameter to obtain the ROI detection result. In the training process of the feature extraction parameter, the first feature data in the query space and the second feature data in the value space are introduced to determine the inter-region difference data between the region associated with the label ROI and the region not associated with the label ROI, and the to-be-trained parameter including the feature extraction parameter in the ROI detection model is adjusted according to the inter-region difference data so that the feature extraction capability of the trained feature extraction parameter is better, thereby significantly improving the accuracy of the obtained ROI prediction result during ROI prediction.

The apparatus for detecting an ROI may perform the method for detecting an ROI provided by any embodiment of the present disclosure and functional modules and beneficial effects corresponding to the performed the method for detecting an ROI.

In the solutions of the present disclosure, the collection, storage, use, processing, transmission, provision, and disclosure of the sample image and the to-be-trained image involved are in compliance with provisions of relevant laws and regulations and do not violate public order and good customs.

According to an embodiment of the present disclosure, the present disclosure further provides an electronic device, a readable storage medium and a computer program product.

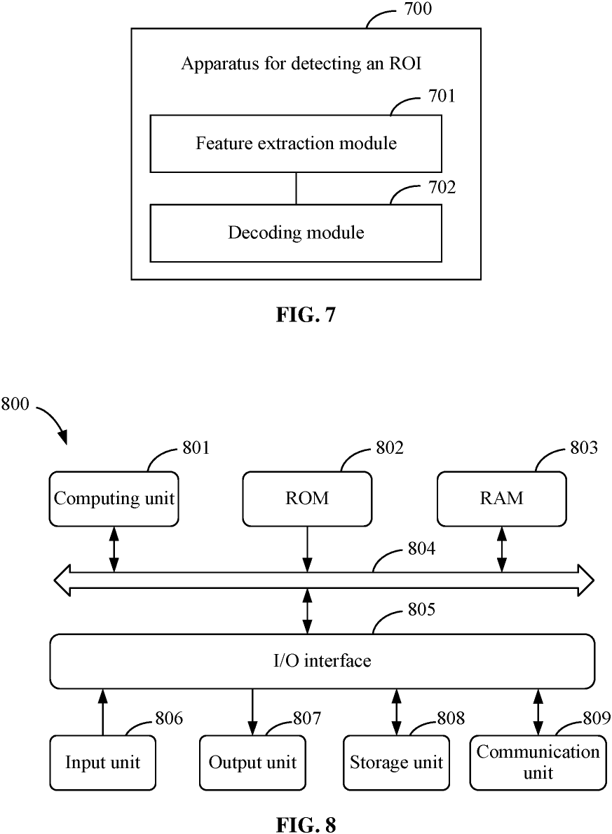

FIG. 8 is an example block diagram of an example electronic device 800 that may be used for performing the embodiments of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present application as described and/or claimed herein.

As shown in FIG. 8, the device 800 includes a computing unit 801. The computing unit 801 may perform various types of appropriate operations and processing based on a computer program stored in a read-only memory (ROM) 802 or a computer program loaded from a storage unit 803 to a random-access memory (RAM) 803. Various programs and data required for the operation of the device 800 may also be stored in the RAM 803. The computing unit 801, the ROM 802 and the RAM 803 are connected to each other via a bus 804. An input/output (I/O) interface 805 is also connected to the bus 804.

Multiple components in the device 800 are connected to the I/O interface 805. The multiple components include an input unit 806 such as a keyboard or a mouse, an output unit 807 such as various types of displays or speakers, the storage unit 808 such as a magnetic disk or an optical disc, and a communication unit 809 such as a network card, a modem or a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Some examples of the computing unit 801 include, but are not limited to, central processing units (CPUs), graphics processing units (GPUs), various special-purpose artificial intelligence (AI) computing chips, various computing units running machine learning models and algorithms, digital signal processors (DSPs), and any suitable processors, controllers and microcontrollers. The computing unit 801 executes various methods and processing described above, such as at least one of the method for training an ROI detection model and the method for detecting an ROI. For example, in some embodiments, at least one of the method for training an ROI detection model and the method for detecting an ROI may be implemented as a computer software program tangibly contained in a machine-readable medium such as the storage unit 808. In some embodiments, part or all of computer programs may be loaded and/or installed on the device 800 via the ROM 802 and/or the communication unit 809. When the computer programs are loaded into the RAM 803 and executed by the computing unit 801, one or more steps of the method for training an ROI detection model or the method for detecting an ROI may be performed. Alternatively, in other embodiments, the computing unit 801 may be configured, in any other suitable manner (for example, by means of firmware), to perform at least one of the method for training an ROI detection model and the method for detecting an ROI.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementation of the methods of the present disclosure may be written in one programming language or any combination of multiple programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device or any suitable combination thereof.

In order to provide the interaction with a user, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service. The server may also be a server of a distributed system, or a server combined with a blockchain.

Artificial intelligence is the study of making computers simulate certain human thinking processes and intelligent behaviors (such as learning, reasoning, thinking and planning), including technologies at both the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

It is to be understood that various forms of the preceding flows may be used with steps reordered, added, or removed. For example, the steps described in the present disclosure may be executed in parallel, in sequence, or in a different order as long as the desired result of the technical solutions provided in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A method for training a region of interest (ROI) detection model, the method comprising:
performing feature extraction on a sample image to obtain a sample feature data;
performing non-linear mapping on the sample feature data to obtain a first feature data and a second feature data; wherein the first feature data indicates a feature mapping result in a query space, and the second feature data indicates a feature mapping result in a value space;
determining an inter-region difference data according to a third feature data of the first feature data in a region associated with a label ROI and the second feature data; and
adjusting, according to the inter-region difference data and the region associated with the label ROI, at least one of a to-be-trained feature extraction parameter and a to-be-trained feature enhancement parameter of the ROI detection model to obtain at least one of a trained feature extraction parameter and a trained feature enhancement parameter.

2. The method according to claim 1, wherein the determining an inter-region difference data according to a third feature data of the first feature data in a region associated with a label ROI and the second feature data and comprises:
determining an ROI global feature data according to the third feature data; and
determining the inter-region difference data according to the ROI global feature data and the second feature data.

3. The method according to claim 2, wherein the determining the inter-region difference data according to the ROI global feature data and the second feature data comprises:
performing feature enhancement on the second feature data according to the ROI global feature data to obtain an ROI enhancement feature data; and
performing activation processing on the ROI enhancement feature data to obtain the inter-region difference data.

4. The method according to claim 2, wherein the determining an ROI global feature data according to the third feature data comprises:
performing sampling on the third feature data to obtain an ROI reference feature data; and determining the ROI global feature data according to the ROI reference feature data.

5. The method according to claim 1, wherein the adjusting at least one of a to-be-trained feature extraction parameter and a to-be-trained feature enhancement parameter of the ROI detection model to obtain at least one of a trained feature extraction parameter and a trained feature enhancement parameter comprises:
determining a target feature extraction loss according to the inter-region difference data and the region associated with the label ROI; and
according to the target feature extraction loss, adjusting the to-be-trained feature extraction parameter and the to-be-trained feature enhancement parameter to obtain the trained feature extraction parameter and the trained feature enhancement parameter.

6. The method according to claim 5, wherein the region associated with the label ROI comprises at least one of: the label ROI and a local region of the label ROI.

7. The method according to claim 6, wherein in a case where the region associated with the label ROI comprises the label ROI and the local region of the label ROI, the determining a target feature extraction loss according to the inter-region difference data and the region associated with the label ROI comprises:
determining a first feature extraction loss according to the label ROI and an inter-region difference data corresponding to the label ROI;
determining a second feature extraction loss according to an inter-region difference data corresponding to the local region of the label ROI and the local region of the label ROI; and
determining the target feature extraction loss according to the first feature extraction loss and the second feature extraction loss.

8. The method according to claim 6, wherein the local region of the label ROI comprises a central region of the label ROI.

9. A method for detecting a region of interest (ROI) according to a trained feature extraction parameter that is trained using the method of claim 1, the method comprising:
obtaining prediction feature data by performing feature extraction on a to-be-detected image according to the trained feature extraction parameter; and
performing decoding processing on the prediction feature data according to a trained decoding parameter to obtain an ROI prediction result.

10. An electronic device, comprising:
at least one processor; and
a memory communicatively connected to the at least one processor;
wherein the memory stores instructions executable by the at least one processor, and the instructions are executed by the at least one processor to enable the at least one processor to perform the following:
performing feature extraction on a sample image to obtain a sample feature data;
performing non-linear mapping on the sample feature data to obtain a first feature data and a second feature data; wherein the first feature data indicates a feature mapping result in a query space, and the second feature data indicates a feature mapping result in a value space;
determining an inter-region difference data according to a third feature data of the first feature data in a region associated with a label region of interest (ROI) and the second feature data; and
adjusting, according to the inter-region difference data and the region associated with the label ROI, at least one of a to-be-trained feature extraction parameter and a to-be-trained feature enhancement parameter of the ROI detection model to obtain at least one of a trained feature extraction parameter and a trained feature enhancement parameter.

11. The electronic device according to claim 10, wherein the at least one processor determines the inter-region difference data by:
determining an ROI global feature data according to the third feature data; and
determining the inter-region difference data according to the ROI global feature data and the second feature data.

12. The electronic device according to claim 11, wherein the at least one processor determines the inter-region difference data by:
performing feature enhancement on the second feature data according to the ROI global feature data to obtain an ROI enhancement feature data; and
performing activation processing on the ROI enhancement feature data to obtain the inter-region difference data.

13. The electronic device according to claim 11, wherein the at least one processor determines the ROI global feature data by:
performing sampling on the third feature data to obtain an ROI reference feature data; and determining the ROI global feature data according to the ROI reference feature data.

14. The electronic device according to claim 10, wherein the at least one processor adjusts at least one of a to-be-trained feature extraction parameter and a to-be-trained feature enhancement parameter of the ROI detection model by:
determining a target feature extraction loss according to the inter-region difference data and the region associated with the label ROI; and
adjusting, according to the target feature extraction loss, the to-be-trained feature extraction parameter and the to-be-trained feature enhancement parameter to obtain the trained feature extraction parameter and the trained feature enhancement parameter.

15. The electronic device according to claim 14, wherein the region associated with the label ROI comprises at least one of: the label ROI and a local region of the label ROI.

16. The electronic device according to claim 15, wherein in a case where the region associated with the label ROI comprises the label ROI and the local region of the label ROI, the at least one processor determines a target feature extraction loss by:
determining a first feature extraction loss according to the label ROI and an inter-region difference data corresponding to the label ROI;
determining a second feature extraction loss according to an inter-region difference data corresponding to the local region of the label ROI and the local region of the label ROI; and
determining the target feature extraction loss according to the first feature extraction loss and the second feature extraction loss.

17. The electronic device according to claim 15, wherein the local region of the label ROI comprises a central region of the label ROI.

18. An electronic device configured to carry out a method for detecting the ROI according to claim 9, the electronic device comprising:
at least one processor; and
a memory communicatively connected to the at least one processor;
wherein the memory stores instructions executable by the at least one processor, and the instructions are executed by the at least one processor to enable the at least one processor to perform the method for detecting the ROI.

19. A non-transitory computer-readable storage medium storing computer instructions, wherein the computer instructions are used for enabling a computer to perform the method for training a region of interest (ROI) detection model according to claim 1.

20. A non-transitory computer-readable storage medium storing computer instructions, wherein the computer instructions are used for enabling a computer to perform the method for detecting the ROI according to claim 9.
